(19) United States
(12) Patent Application Publication
(10) Pub. No.: US 2023/0066879 A1
(43) Pub. Date: Mar. 2, 2023

(54) DRY PROCESS FOR SYNTHESIS OF A PHOSPHOR BY TREATMENT UNDER A FLUORINE ATMOSPHERE

(71) Applicants: CENTRE NATIONAL DE LA RECHERCHE SCIENTIFIQUE, Paris (FR); UNIVERSITE CLERMONT AUVERGNE, CLERMONT-FERRAND (FR); SIGMA CLERMONT, AUBIERE CEDEX (FR)

(72) Inventors: Boyer DAMIEN, CEBAZAT (FR); Kumar VINOD, CLERMONT-FERRAND (FR); Guerin-Araujo Da Silva KATIA, PONT DU CHATEAU (FR); Boutinaud PHILIPPE, COURNON D'AUVERGNE (FR)

(21) Appl. No.: 17/797,008

(22) PCT Filed: Feb. 3, 2021
(86) PCT No.: PCT/EP2021/052576

§ 371 Date: Sep. 16, 2022

(30) Foreign Application Priority Data
Feb. 3, 2020 (FR) 2001050

(51) Int. Cl. C09K 11/61

(52) U.S. Cl. CPC C09K 11/617

(57) ABSTRACT

A process for the dry synthesis of a luminophore of formula Aₓ[BF_{y}]:C includes a stage of providing an initial composition comprising at least two synthetic precursors and at least one chemical doping source, a stage of heating the initial composition up to a fluorination temperature under an inert atmosphere or under vacuum, a stage of treatment under a fluorine atmosphere of the composition obtained on conclusion of the heating stage and a stage of returning to ambient temperature under an inert atmosphere. A composition comprising a luminophore of formula Aₓ[BF_{y}]:C and obtained according to the synthetic process described above, the composition being devoid of hydrogen fluoride.

### TECHNICAL FIELD OF THE INVENTION

The invention comes within the field of the synthesis of luminescent materials. The invention relates particularly to a process for the dry synthesis of a luminophore.

### PRIOR ART

The light-emitting diode sector has been booming for many years now and the use of such devices is becoming more and more widespread. In particular, the combinations of luminophores emitting light at different wavelengths are particularly studied or even already marketed. This is because the use of these combinations of luminophores is applicable in many fields and is particularly advantageous technically and commercially.

Such luminophores are widely known in the prior art. For example, the patent application WO 2007/100824 A2 discloses numerous fluorinated luminophores of formula Aₓ[MF_{y}]:Mn⁴⁺ which are used in combination with other light sources to produce white light. Such fluorinated luminophores can also be used individually in certain applications, in particular because of their capacities for emissions in a narrow band of wavelengths.

Thus, processes for the production of luminophores emitting at advantageous narrow-band wavelengths and demonstrating a better quality and/or a better durability are especially sought after. Also, the improvement in the yield for production of these luminophores by such processes and also the improvement in the energy balance of such processes are of essential interest for the industry in the field.

The abovementioned patent application WO 2007/100824 A2 discloses several processes in which synthetic compounds, such as K₂[TiF₆], K₂[MnF₆] or K₂[SiF₆], are dissolved in an aqueous solution containing at least 40% of hydrofluoric acid. Subsequently, this solution comprising these synthetic compounds is evaporated until the final product is dry.

The patent application WO 2017/081428 A2 in its turn discloses a sol-gel process for the synthesis of a luminescent material of general formula AxByFz:Mn by the production of a liquid precursor in alcoholic solution.

The patent application US 2016/0289553 A1 also discloses a process for the synthesis of a luminophore doped with manganese. In particular, the application discloses the use of a saturated solution of K₂SiF₆, initially prepared by the dissolution of the compound K₂SiF₆ in a 40% hydrofluoric acid solution.

The processes of the art are processes which comprise a liquid route and most of which use hydrofluoric acid. However, hydrofluoric acid is a particularly corrosive chemical compound, the use of which is regulated by the necessary authorizations, the transportation of which is considered to be the transportation of hazardous materials and the toxicity of which for the environment has been demonstrated. In addition, hydrofluoric acid is an agent having a strong affinity for calcium, making possible the fixation in teeth, bones and blood. Its use requires compliance with occupational exposure limit values set, for example, by French regulations (Article R4412-149 of the Labor Code).

Also, hydrofluoric acid or one of its derivatives, when it is used in liquid-phase processes for the preparation of luminophores, can be found trapped in the final product in the form of a molecular group, which can affect the stability and the durability of the luminophore. This is because the presence of hydrofluoric acid during the processes of the prior art forms, by a chain of reactions, molecular groups such as, for example, HF₂⁻ or KHF₂. These molecular groups are the cause of a mechanism of degradation, premature aging of the final luminophore, in particular indicated in the paper “K₂MnF₆ as a Precursor for Saturated Red Fluoride Phosphors: the Struggle for Structural Stability”, Reinert Verstraete et al., Journal of Materials Chemistry C, 2017, 5, 10761-10769. The abovementioned molecular groups can in particular interact with manganese, which reduces the quality of the final luminophore. In order to remove these residues, the processes of the prior art generally require a post-treatment.

The invention is targeted at overcoming the abovementioned disadvantages of the prior art.

More particularly, production processes are thus sought which make it possible to obtain efficient luminophores stable in the long term without using liquid-phase compounds, and/or without requiring post-treatment. Advantageously, a process for the production of luminophores is sought, the production energy balance of which is at least equal to, indeed even better than, that of the known methods and which is less toxic to the environment, for example using fewer toxic compounds, in particular which does not use hydrofluoric acid, especially in aqueous solution.

### DISCLOSURE OF THE INVENTION

The invention relates to a process for the dry synthesis of a luminophore of formula Aₓ[BF_{y}]:C. The process comprises:

a) a stage of providing an initial composition, the initial composition comprising at least one first synthetic precursor A′, at least one second synthetic precursor B′ and at least one chemical doping source C′;
b) a stage of heating the initial composition up to a fluorination temperature of between 200 and 550° C., the heating stage being carried out under an inert atmosphere and/or under vacuum;
c) a stage of treatment under a fluorine atmosphere of the composition obtained on conclusion of stage b) comprising two successive substages:
c1) a substage of maintaining at the fluorination temperature,
c2) a substage of cooling from the fluorination temperature down to a temperature of less than or equal to 150° C.;
d) a stage of returning the composition obtained on conclusion of stage c) to ambient temperature under an inert atmosphere.

The element A of the luminophore of formula Aₓ[BF_{y}]:C obtained by the process of the present invention is a chemical element from Li, Na, K, Rb and Cs or a combination of at least two of these chemical elements. The subscript x corresponds to the number of atoms of the element A, x being equal to 1, 2 or 3. Preferentially, x is equal to 2.

The element B of the luminophore of formula Aₓ[BF_{y}]:C obtained by the process of the present invention is a chemical element from the chemical elements Si, Ge, Sn, Ti, Zr, Al, Ga, In, Sc, Hf, Y, La, Nb, Ta, Bi and Gd or a combination of at least two of these chemical elements. Preferably, the element B of the luminophore of formula Aₓ[BF_{y}]:C obtained by the process of the present invention is a chemical element from the chemical elements Si, Ti and Ge.

The element F of the luminophore of formula Aₓ[BF_{y}]:C obtained by the process of the present invention is fluorine, and the element C is a doping chemical element. The subscript y corresponds to the number of atoms of the element fluorine, y being equal to 5, 6 or 7. Preferentially, y is equal to 6.

Luminophores of formula Aₓ[BF_{y}]:C which can be obtained by the process of the invention are, for example, KTeF₅:Mn⁴⁺, K₂GeF₆:Mn⁴⁺, K₂SiF₆:Mn⁴⁺, Na₂SiF₆:Mn⁴⁺ and K₃SiF₇:Mn⁴⁺. Preferentially, the luminophores obtained by the process of the present invention are the luminophores K₂SiF₆:Mn⁴⁺ and Na₂SiF₆:Mn⁴⁺.

The term “dry synthesis” is understood to mean that the process for the synthesis of the luminophore is carried out using an initial composition which consists of solid constituents and that the process is carried out without using liquids. The dry synthesis process is in contrast to the liquid processes of the state of the art in that the latter are carried out using an initial composition which has been treated with a liquid or which comprises at least one liquid constituent. The dry synthesis process of the present invention thus uses precursors and a doping source which are anhydrous.

The term “synthetic precursors” is understood to mean a chemical element or compound which, by its transformation, gives rise to a new intermediate or final body. The first synthetic precursor A′ is the chemical element or compound making it possible to obtain the element A in the luminophore of formula Aₓ[BF_{y}]:C. The second synthetic precursor B′ is the chemical element or compound making it possible to obtain the element B in the luminophore of formula Aₓ[BF_{y}]:C. The doping source C′ is the chemical element or compound making it possible to obtain the element C in the luminophore of formula Aₓ[BF_{y}]:C.

The term “chemical doping source” is understood to mean one or more chemical elements or chemical compounds which are added to a body during chemical doping in order to confer specific properties on said body. In the present invention, chemical doping by a manganese-comprising element may confer luminescence properties on the luminophore.

Advantageously, the maintenance substage c1) is carried out for a period of time of 30 minutes to 8 hours.

Advantageously, the synthetic precursor A′ comprises a chemical element from the alkali metals or a combination of these chemical elements, preferably comprising a chemical element from the elements Li, Na, K, Rb and Cs or a combination of these chemical elements, the preferred chemical elements being the elements K and Na.

More advantageously still, the first synthetic precursor A′ is a Li, Na, K, Rb or Cs halide or a combination of these first synthetic precursors. The halides KBr, NaBr, KCl, NaCl are the preferred synthetic precursors A′, the anhydrous form being preferred.

Advantageously, the second synthetic precursor B′ comprises at least one chemical element from Si, Ge, Sn, Ti, Zr, Al, Ga, In, Sc, Hf, Y, La, Nb, Ta, Bi, Gd or a combination of these chemical elements.

More advantageously still, the second synthetic precursor B′ comprises at least one chemical element from Si, Ge and Ti or a combination of these chemical elements.

More advantageously still, the second synthetic precursor B′ comprises at least one chemical element from Si and Ti. Preferably, the second synthetic precursor B′ is Si, Ti, SiO_{z} or TiO_{z} or a combination of these, z being equal to 1 or 2. Si and Ti are the preferred synthetic precursors B′.

Advantageously, the chemical doping source C′ comprises at least one chemical element from the transition metals of 3dⁿ electronic configuration (with n=[1,10]), that is to say from Sc, Ti, V, Cr, Mn, Fe, Co, Ni and Cu or a combination of these transition metals. Preferably, the chemical doping source C′ comprises at least the chemical element manganese.

More advantageously still, the chemical doping source C′ is chosen from the following list: Mn, KMnO₄, MnO, MnO₂, MnBr₂, K₂MnF₆, MnF₃, MnF₂, MnCl₃ and MnCl₂, or a combination of these, the preferred doping sources C′ being MnCl₂ and MnCl₃.

A person skilled in the art will know how to adapt the composition comprising at least one first synthetic precursor A′, at least one second synthetic precursor B′ and at least one chemical doping source C′ according to the luminophore of formula Aₓ[BF_{y}]:C to be obtained on conclusion of the process of the invention. The choice of the first synthetic precursor A′ does not have as consequence a limitation on the choice of the second synthetic precursor B′ and of the doping source C′. Equally, the choice of the second synthetic precursor B′ does not have as consequence a limitation on the choice of the first synthetic precursor A′ and of the doping source C′. Finally, the choice of the doping source C′ does not have as consequence a limitation on the choice of the first synthetic precursor A′ and of the second synthetic precursor B′.

Advantageously, the first synthetic precursor A′ and/or the second synthetic precursor B′ and/or the doping source C′ are in the form of powders consisting of grains. Preferentially, the particle size of at least one of these powders is between 10 nm and 100 μm. Preferentially, the particle size of the first synthetic precursor A′ and/or the particle size of the second synthetic precursor B′ and/or the particle size of the doping source C′ are between 100 nm and 50 μm. The respective particle sizes of the first synthetic precursor A′, of the second synthetic precursor B′ and of the doping source C′ are not linked to one another.

The term “powder” is understood to mean that the first synthetic precursor A′ and/or the second synthetic precursor B′ and/or the doping source C′ in the initial composition are in the finely divided state, consisting of grains.

Preferentially, the first synthetic precursor A′ has a particle size of between 100 nm and 50 μm. More preferentially still, this particle size is between 1 and 5 μm.

Preferentially, the second synthetic precursor B′ has a particle size of between 100 nm and 50 μm. More preferentially still, this particle size is between 1 and 5 μm.

Preferentially, the chemical doping source C′ has a particle size of between 100 nm and 50 μm. More preferentially still, this particle size is between 1 and 10 μm.

A person skilled in the art will know how to adapt the particle size of the synthetic precursor A′, of the synthetic precursor B′ and of the chemical doping source C′ according to the luminophore of formula Aₓ[BF_{y}]:C to be obtained on conclusion of the process of the invention. The smaller the particle size, the greater the specific surface of the grains of synthetic precursors or chemical doping source.

The term “specific surface” is understood to mean the sum of the surface areas of the grains. Thus, the smaller the particle size, the greater the interaction of the first synthetic precursor A′, of the second synthetic precursor B′ and of the doping source C′ with the environment. Consequently, the greater the specific surface of the grains of the synthetic precursors and of the doping source, the greater the reactivity, the faster the synthesis and/or the lower the temperature necessary during the treatment stage c) may be.

Preferably, the initial composition provided comprises a first synthetic precursor A′ and a second synthetic precursor B′, the molar ratio A′/B′ (first synthetic precursor A′/second synthetic precursor B′) of which is between 5 and 0.5. More preferentially still, the molar ratio A′/B′ (first synthetic precursor A′/second synthetic precursor B′) is between 1 and 2.5.

Preferentially, the initial composition provided comprises a second synthetic precursor B′ and a doping source C′, the molar ratio B′/C′ (second synthetic precursor B′/doping source C′) of which is between 50 and 5. More preferentially still, the molar ratio B′/C′ (second synthetic precursor B′/chemical doping source C′) is between 10 and 30.

Preferentially, the amount of doping element C in the luminophore of formula Aₓ[BF_{y}]:C obtained on conclusion of the process of the present invention is between 0.5% and 2% (by weight) of the total weight of the luminophore of formula Aₓ[BF_{y}]:C. Preferably, this amount of doping element C is between 0.75% and 1.5% (by weight) of the total weight of the luminophore of formula Aₓ[BF_{y}]:C.

Advantageously, the initial composition before the heating stage b) is homogeneous. The term “homogeneous” is understood here to mean that the initial composition has been mixed so that it comprises constituents which are uniformly distributed. Preferentially, the initial composition before the heating stage b) is in the form of a homogeneous powder, that is to say that the initial composition comprises the first synthetic precursor A′, the second synthetic precursor B′ and the chemical doping source C′ which are all in powder form and are uniformly distributed in the initial composition.

The initial composition can be homogeneous when it is provided. If the initial composition is not homogeneous when it is provided, a stage of homogenization of the initial composition prior to the heating stage b) is preferentially carried out.

If at least one of the constituents of the initial composition from the first synthetic precursor A′, the second synthetic precursor B′ and the chemical doping source C′ does not have a particle size between 100 nm and 50 μm before the heating stage b), a stage of grinding this or these constituents of the initial composition can be carried out prior to the heating stage b), before or after the provisioning stage a).

Optionally, a stage of grinding at least one of the constituents of the initial composition and then a stage of homogenization of the initial composition are carried out before the heating stage b) if, for example, at least one of the constituents of the initial composition does not have a particle size between 100 nm and 50 μm before the heating stage. This stage of grinding at least one of the constituents of the initial composition can be carried out in any device making possible the grinding of a powder, such as in a mortar using a pestle or in a planetary mill having balls of suitable compositions and dimensions. Preferably, the grinding of at least one of the constituents is carried out with ethanol, this making it possible to improve the synthesis yields.

The homogenization stage makes it possible for the heating b) and also for the treatment under a fluorinated atmosphere c) of the initial composition to be applied in a substantially identical manner to all of the constituents of the initial composition. The homogenization stage thus makes possible better control of the process for obtaining a luminophore of formula Aₓ[BF_{y}]:C. Also, the homogenization makes possible a better distribution of the doping element C within the final luminophore.

Preferentially, the grinding of the initial composition is carried out in a planetary ball mill for a period of time of between 1 and 60 minutes, more preferentially from 10 to 30 minutes. The grinding is preferentially carried out at a speed of 800 to 2000 rpm, more preferentially of 1200 to 1600 rpm. The grinding is also carried out at a temperature of between 40 and 80° C., more preferentially between 50 and 70° C.

A person skilled in the art will know how to adapt the speed and the duration of the grinding according to the first synthetic precursor A′, the second synthetic precursor B′ and the doping source C′ of the initial composition and/or according to the particle size of the constituents of the desired initial composition after the grinding stage and/or according to the desired particle size of the luminophore of formula Aₓ[BF_{y}]:C obtained on conclusion of the process of the present invention.

The process of the present invention comprises a stage b) of heating the initial composition up to a fluorination temperature of between 200 and 550° C. The heating stage is carried out under an inert atmosphere and/or under vacuum. A fluorination temperature of between 200 and 550° C. promotes the carrying out of chemical reactions when the heated initial composition is brought into contact with a fluorine gas during the stage of treatment under a fluorine atmosphere. Preferentially, the fluorination temperature is between 300 and 400° C., 350° C. being the preferred fluorination temperature.

Prior to the stage of treatment under a fluorine atmosphere, the atmosphere is inert or under vacuum.

The term “inert atmosphere” is understood to mean a gas atmosphere consisting of a gas or gas mixture which is inert, that is to say which is not chemically reactive, which is non-combustible and non-oxidizing, in order to exclude unwanted chemical reactions with the initial composition and to exclude the risk of an accidental phenomenon.

The term “inert with respect to fluorine” is understood to mean that the atmosphere in which the initial composition is placed before the start of the stage of treatment under a fluorine atmosphere is an atmosphere which does not comprise, or comprises as little as possible of, elements making possible a reaction with fluorine, and in particular does not comprise elements making possible the formation of hydrogen fluoride. This is because, if the atmosphere is not inert or if a prior stage of placing under vacuum has not been carried out when the stage of treatment under a fluorine atmosphere of the initial composition begins, the fluorine, when it is flushed, can react with the atmosphere and form undesired elements. The products of reaction of fluorine with the atmosphere in which the initial composition is placed can be found in particular in the initial composition and/or in the luminophore of formula Aₓ[BF_{y}]:C obtained by the process of the invention, which is not desired. The term “flushed” is understood to mean that a gas is displaced within a reactor to be replaced by another gas. For example, when fluorine flushing is carried out in a chamber, the gas previously present in the chamber is displaced and the fluorine gas replaces it.

The heating stage b) is carried out under an inert atmosphere or under vacuum. In this case, inerting or placing under vacuum can be carried out prior to the heating of the initial composition. The term “inerting” is understood to mean the replacement of an explosive or chemically reactive atmosphere by a gas atmosphere consisting of a gas or gas mixture which is inert, that is to say which is not chemically reactive, which is non-combustible and non-oxidizing, in order to exclude unwanted chemical reactions with the initial composition and to exclude the risk of an accidental phenomenon. A first embodiment comprises solely an inerting stage prior to the heating stage b). A second embodiment comprises solely a stage of placing under vacuum prior to the heating stage b).

Preferentially, the inert atmosphere is a nitrogen or argon atmosphere. The inert atmosphere makes it possible to prevent the production of impurities or of byproducts in the initial composition and to exclude the risk of an accidental phenomenon and the deterioration of the constituents by oxidation.

Preferentially, stage b) of heating the initial composition is carried out under an inert atmosphere up to a fluorination temperature.

Preferentially, the heating stage b) is carried out with an increase in temperature of 5 to 60° C. per minute, more preferably still of 5 to 15° C. per minute, preferentially of the order of about ten degrees per minute.

Preferentially, the heating stage is carried out in a fluorination reactor which will also be the oven in which stage c) of treatment under a fluorine atmosphere is carried out. Such a fluorination oven can be a tubular oven.

In a specific embodiment, the inerting is carried out by flushing with pure nitrogen with a turbulent flow. Such a turbulent flow makes it possible to prevent any residual trace of moisture or oxygen in the reactor. Preferentially, the inerting has a duration of at least one hour.

Stage c) of treatment under a fluorine atmosphere comprises a substage c1) of maintaining at the fluorination temperature. This stage c1) is preferably carried out for a duration of between 30 minutes and 8 hours. Such a duration of stage c1) is suitable for obtaining a maximum yield of synthesis of luminophore of formula Aₓ[BF_{y}]:C with respect to the amount of initial composition provided in stage a). More preferentially still, this duration is between 1 hour and 6 hours, 3 hours being the preferred duration.

Stage c) of treatment under a fluorine atmosphere can be carried out in static mode or in dynamic mode. The term “static mode” is understood to mean the injection of an initial amount of fluorine into a closed oven, the initial composition thus being isolated in the oven with the initial amount of fluorine. In particular, the oven can be placed under vacuum and then the fluorine is injected up to the desired pressure. The static mode makes it possible to keep reaction by-products in the reaction environment which might promote the desired reactivity. The term “dynamic mode” is understood to mean the introduction of fluorine under continuous and controlled flow into a reactor by an inlet and an outlet through which the excess fluorine leaves the reactor and is neutralized in particular by a trap, for example a soda lime trap. In the dynamic mode, the reaction environment is constantly renewed in fluorine.

The term “under a fluorine atmosphere” is understood to mean that the inert atmosphere present before the treatment stage is replaced during the treatment stage by a fluorine atmosphere, more specifically a difluorine atmosphere. Also preferably, the flushing of fluorine during the treatment stage is carried out with a flow rate of between 10 and 100 ml/min for a 1-liter reactor. More preferentially still, this flow of fluorine is injected with a laminar flow which does not set the initial composition in motion and promotes the exchanges, at a pressure of 1 Atm (1.013 bar). The difluorine gas is concentrated to at least 20% by volume of fluorine, the remainder being inert gas, and is brought into contact with the initial composition, preferentially at least during substage c1) of maintaining at the fluorination temperature, preferentially for 30 minutes to 8 hours. In a preferred mode, the difluorine gas is concentrated to at least 98% (purity by volume) and is brought into contact with the initial composition at least during substage c1) of maintaining at the fluorination temperature, preferentially for 30 minutes to 8 hours. Also, the difluorine gas can be brought into contact with the initial composition during substage c2) of cooling down to a temperature of 150° C. Optionally, the difluorine gas can be diluted with an inert gas before it is brought into contact with the initial composition. In some embodiments, the fluorine can be injected only during a part of substage c1) of maintaining at the fluorination temperature. The fluorine may be injected only for 30 minutes during the fluorination stage, for example injected for 30 minutes from the start of the fluorination stage, then without injection of fluorine for the following 2 hours 30 minutes.

In a preferred mode, a percentage of at least 98% of difluorine gas brought into contact with the initial composition during the treatment stage makes it possible to lower the temperatures necessary for the treatment under a fluorine atmosphere compared with the methods of the art. Such a percentage is advantageous because the reactivity of the fluorination is greater than the processes of the prior art. Also, since the temperature necessary for the treatment of the composition is lower than that of the processes of the prior art, the process of the present invention makes possible a decrease in the energy consumption and easier control of the stage of treatment under a fluorine atmosphere.

In particular, stage c) of treatment under a fluorine atmosphere of the composition obtained on conclusion of the heating stage does not comprise the use of catalysts or of additives.

Advantageously, substage c2) of cooling from the fluorination temperature down to a temperature of less than or equal to 150° C. is carried out at a pressure of 1 bar and according to a decrease in the temperature of 5 to 10° C. per minute, preferentially of the order of about ten degrees per minute. Such a cooling stage makes it possible in particular to freeze the composition and to maintain the desired stoichiometry in the final luminophore.

Advantageously, stage d) of returning to ambient temperature is carried out under an inert atmosphere by replacement of the fluorine atmosphere with an inert atmosphere, such as a nitrogen atmosphere. Preferentially, the fluorine flow of the cooling substage is replaced with a nitrogen flow down to the decrease in the temperature to ambient temperature, making it possible to save on fluorine.

Unlike the methods of the prior art, the process of the present invention does not comprise a stage passing through a liquid phase, and in particular does not comprise the use of a solution of hydrofluoric acid, which is a liquid, the use of which is regulated by the necessary authorizations and the toxicity of which for the environment has been demonstrated. In addition, hydrofluoric acid is a powerful corrosive and an agent having a strong affinity for calcium, making possible the fixation in teeth, bones and blood. Its use requires compliance with occupational exposure limit values set, for example, by French regulations (Article R4412-149 of the Labor Code). The process of the present invention is carried out entirely by dry synthesis and is thus less toxic for the environment. The process does not use hydrofluoric acid, making possible reduced necessary safety aspects.

The process of the present invention makes it possible to obtain a luminophore of formula Aₓ[BF_{y}]:C by providing an initial composition comprising synthetic precursors A′ and B′ and a chemical doping source C′ without use of intermediate synthetic compounds, such as in the processes of the prior art, for example K₃[ZrF₇], K₂[MnF₆] or MAIN, to obtain which often comprises the use of hydrofluoric acid in aqueous solution.

The process of the present invention also makes possible a reduction in the intrinsic energy used to obtain a luminophore of formula Aₓ[BF_{y}]:C. This is because the intrinsic energy consumed for the present invention, that is to say the amount of energy consumed during the cycle for production of such a luminophore, is lower than that necessary in the known liquid or semi-liquid processes. This is because the manufacture of the luminophore of formula Aₓ[BF_{y}]:C, the transportation and storage of the synthetic precursors A′ and B′ and of the chemical doping source C′ in the process of the present invention consume less intrinsic energy in comparison with the methods of the art because the process does not use liquid compounds and comprises fewer intermediate stages. In addition, such a dry synthesis process is advantageous for a transfer of the process to the industrial scale in comparison with a liquid process. Also, the process does not require a mandatory post-treatment.

The stage of treatment under a fluorine atmosphere of the composition is also better controlled than during a liquid fluorination using hydrofluoric acid. This is because the process of the present invention makes it possible to exert increased control over the amount of difluorine gas brought into contact with the composition obtained on conclusion of the heating stage. Also, such a process makes it possible to remove an excess of difluorine gas, for example by the use of a soda lime trap.

Unlike certain methods of the prior art, the process according to the present invention comprises the preparation of a composition in which the hydrofluoric acid is not present during the heating stage. The presence of hydrofluoric acid in the composition before the stage of treatment under a fluorine atmosphere is a disadvantage because it has the effect of trapping hydrofluoric acid in the final product, which has the effect of reducing the stability and the purity of the final composition. The process of the present invention makes it possible to obtain a luminophore of formula Aₓ[BF_{y}]:C, the sensitivity to moisture and the stability over time of which are better than the luminophores obtained by the processes of the art comprising the use of hydrofluoric acid.

The luminophore of formula Aₓ[BF_{y}]:C obtained on conclusion of the stage of returning to ambient temperature can be incorporated in a separate and complementary process in order to confer specific properties on it. Said complementary process can comprise a passivation stage and/or a drying stage.

The passivation stage makes it possible to passivate the surface of the luminophore of formula Aₓ[BF_{y}]:C obtained by the process of the invention in order to confer optimal optical properties on it. The passivation stage can comprise the addition of the luminophore obtained after the stage of returning to ambient temperature to a solution comprising several chemical agents over several hours. Preferably, the solution comprises phosphoric acid and hydrogen peroxide.

The drying stage can be carried out by drying under vacuum, preferentially at a temperature of the order of 40° C. and for a period of time of 10 to 20 hours, 15 hours being the preferred period of time.

Before the drying substage, the solution comprising the luminophore is homogenized, preferably for several hours, and then this solution undergoes centrifugation, the product of which is subsequently washed.

### BRIEF DESCRIPTION OF THE FIGURES

Other characteristics and advantages of the invention will become apparent with the help of the description which follows, given by way of illustration and without limitation, made with regard to the appended figure and the example.

FIG. 1 illustrates the stages and substages of a process for the dry synthesis of a luminophore of formula Aₓ[BF_{y}]:C.

FIG. 2 is a graph corresponding to the emission spectrum of a luminophore K₂SiF₆:Mn⁴⁺ obtained according to example 2 or example 3 and excited at 450 nm.

FIG. 3 is a graph corresponding to the excitation spectrum of a luminophore K₂SiF₆:Mn⁴⁺ obtained according to example 2 or example 3 and recorded by monitoring the emission at 629 nm.

FIG. 4 is a graph corresponding to the emission spectrum of a luminophore Na₂SiF₆:Mn⁴⁺ obtained according to example 4 or example 5 and excited at 450 nm.

FIG. 5 is a graph corresponding to the excitation spectrum of a luminophore Na₂SiF₆:Mn⁴⁺ obtained according to example 4 or example 5 and recorded by monitoring the emission at 625 nm.

### DETAILED DESCRIPTION OF THE INVENTION

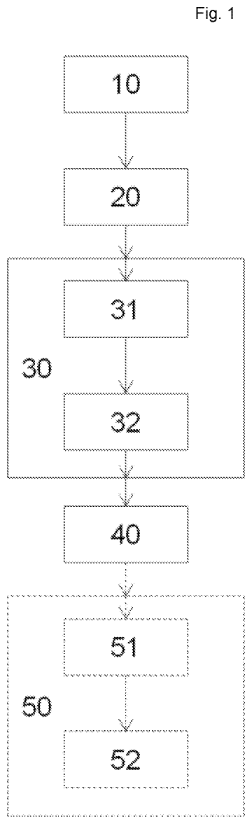

FIG. 1 illustrates the stages and substages of a process for the dry synthesis of a luminophore of formula Aₓ[BF_{y}]:C.

First, a stage of providing 10 an initial composition comprising at least one first and one second synthetic precursor and at least one chemical doping source is carried out.

Secondly, a stage of heating 20 the initial composition up to a fluorination temperature of between 200 and 550° C. is carried out. This heating stage is carried out under an inert atmosphere or under vacuum.

Optionally, before the stage of heating 20 the initial composition up to a fluorination temperature of between 200 and 550° C., the initial composition or the synthetic precursors A′ and B′ and the doping source C′ can be heated to and maintained at 80° C., preferentially for at least 12 hours and under vacuum. This stage of heating to 80° C. can be carried out in a stove outside the fluorination oven or can be carried out directly in the fluorination oven. This preliminary stage makes it possible in particular to exclude the presence of water in the composition or in the synthetic precursors A′ and B′ and the doping source C′.

Thirdly, a stage of treatment 30 under a fluorine atmosphere of the composition obtained on conclusion of the heating stage is carried out, comprising a substage of maintaining 31 at a fluorination temperature for 30 minutes to 8 hours, then a substage of cooling 32 down to a temperature of less than or equal to 150° C.

Fourthly, a stage of returning 40 to ambient temperature under an inert atmosphere the composition obtained on conclusion of the stage of treatment under a fluorine atmosphere is carried out, so as to obtain a luminophore of formula Aₓ[BF_{y}]:C.

Optionally, fifthly, a separate and complementary process 50 is carried out on the luminophore obtained on conclusion of the stage of returning to ambient temperature, comprising a passivation stage 51 consisting of the addition of the luminophore to a solution comprising several chemical agents for several hours, then the mixing of the solution, the centrifugation of the solution and finally the washing of the luminophore and a drying stage 52 which comprises a drying under vacuum.

### Example 1—Process for the Formation of K₂SiF₆:Mn⁴⁺ Dynamically

5 g of a mixture of synthetic precursors and of chemical doping source comprising potassium chloride, silicon and manganese(II) chloride are placed in a 125 ml bowl made of zirconium oxide. Absolute ethanol and zirconium oxide beads are added to the bowl. The grinding of this mixture is carried out for 20 minutes at a speed of 1400 rpm and at a temperature of between 50 and 70° C. and makes it possible to obtain a homogenized initial composition.

The initial composition obtained is placed in a gas fluorination oven, an inerting of which is carried out by flushing with 100 ml of pure nitrogen per minute for at least one hour. The initial composition is subsequently heated under a nitrogen atmosphere with a change in the temperature of the order of about ten degrees per minute up to a temperature of 350° C.

The composition is then maintained at 350° C. with the replacement of the nitrogen atmosphere by a fluorine atmosphere with a flow of 40 ml per minute at a pressure of 1 bar. This maintenance stage lasts 3 hours.

The temperature in the fluorination oven is subsequently reduced by about ten degrees per minute under a fluorine flow down to a temperature of 150° C. The fluorine flow is then replaced by a nitrogen flow of 100 ml per minute while allowing the fluorination oven to cool down until ambient temperature is reached. The final luminophore obtained is a compound K₂SiF₆:Mn⁴⁺ which is advantageous in comparison with the compounds comprising luminophores of the same formula and which can be used in numerous applications in the field of LEDs. The luminophore obtained by the process of the present invention is a luminophore, the purity of which is greater than the luminophores obtained by the processes of the state of the art. Also, the luminophore obtained by the process of the present invention has a durability greater than the processes of the prior art because, in particular, it does not comprise hydrofluoric acid. The durability of a luminophore obtained by the process of the present invention can be tested, for example, by stress tests.

Aging tests have been carried out on samples of luminophores K₂SiF₆:Mn⁴⁺ obtained by the methods of the present invention. The operating conditions comprised the maintenance of an ambient humidity, of a temperature of 20° C. or of 50° C. and illumination by a 450 nm blue LED, the sample being under a photon flux with a power of 183 mW. The tests demonstrated that there was no degradation of the luminophores for a period of time of at least 10 days.

### Example 2—Synthesis of K₂SiF₆:Mn⁴⁺ by Static Fluorination with Heating Under an Inert Atmosphere

The initial composition comprises, as first synthetic precursor A′, potassium bromide (KBr), as second synthetic precursor B′, silicon dioxide (SiO₂), and, as chemical doping source C′, manganese(II) fluoride (MnF₂). The synthetic precursors and the chemical doping source are ground with ethanol and mixed in order to obtain a homogeneous powder. The mixture is placed on a nickel or alumina boat and is introduced into a fluorination oven. A stage of heating the initial composition up to a temperature of 350° C. is carried out under nitrogen. The oven is placed under vacuum, for example at a relative pressure of −1 bar, then an injection of fluorine is carried out, for example up to a relative pressure of −0.2 bar. This state is maintained for 3 hours at the fluorination temperature of 350° C. The oven is subsequently cooled down to a temperature of 20° C., still under a fluorine atmosphere. Flushing with nitrogen is carried out in order to recover the sample. A yellow powder is obtained, characteristic of the compound K₂SiF₆ doped with Mn⁴⁺ ions.

### Example 3—Synthesis of K₂SiF₆:Mn⁴⁺ by Static Fluorination with Heating Under Vacuum

The initial composition and the stages of example 2 are reproduced with as sole difference that the stage of heating the initial composition up to a temperature of 350° C. is carried out under vacuum. The results obtained relating to the quality of the luminophores obtained during example 2 are identical.

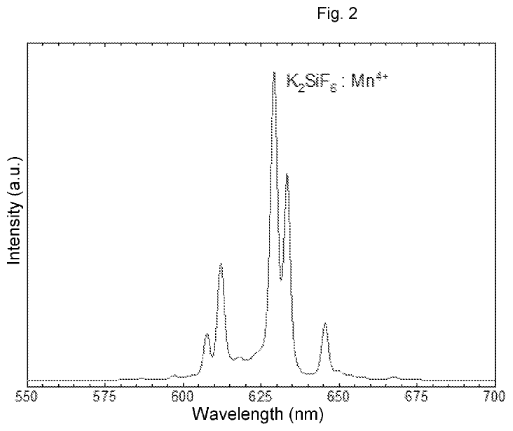

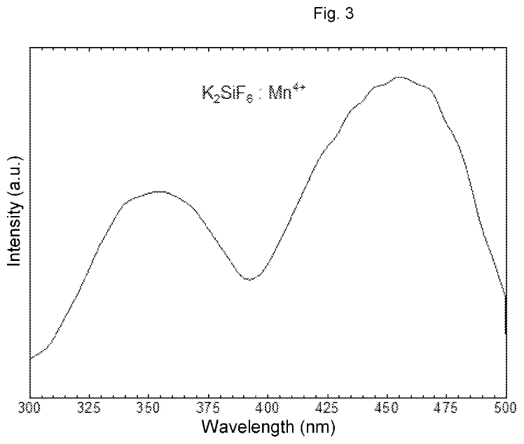

The emission spectra of the luminophores K₂SiF₆:Mn⁴⁺ obtained according to example 2 or example 3 are presented in FIGS. 2 and 3 according to an excitation at 450 nm or 629 nm respectively.

### Example 4—Synthesis of Na₂SiF₆:Mn⁴⁺ by Static Fluorination

The initial composition comprises, as first synthetic precursor A′, sodium bromide (NaBr), as second synthetic precursor B′, silicon dioxide (SiO₂), and, as chemical doping source C′, manganese(II) fluoride (MnF₂). The synthetic precursors and the chemical doping source are ground with ethanol and mixed in order to obtain a homogeneous powder. The mixture is placed on a nickel or alumina boat and is introduced into a fluorination oven. A stage of heating the initial composition up to a temperature of 350° C. is carried out under nitrogen. The oven is placed under vacuum, for example at a relative pressure of −1 bar, then an injection of fluorine is carried out, for example up to a relative pressure of −0.2 bar. This state is maintained for 3 hours at the fluorination temperature of 350° C. The oven is subsequently cooled down to a temperature of 20° C., still under a fluorine atmosphere. Flushing with nitrogen is carried out in order to recover the sample. A yellow powder is obtained, characteristic of the compound Na₂SiF₆ doped with Mn⁴⁺ ions.

### Example 5—Synthesis of Na₂SiF₆: Mn⁴⁺ by Static Fluorination

The initial composition and the stages of example 5 are reproduced with as sole difference that the stage of maintenance of the initial composition at a fluorination temperature of 350° C. has a duration of 30 minutes. The results obtained relating to the quality of the luminophores obtained during example 4 are identical. A reaction time of 30 minutes for obtaining luminophores is very fast compared with the methods of the prior art and exhibits a major advantage from an economic point of view by the speed of production and the energy saving.

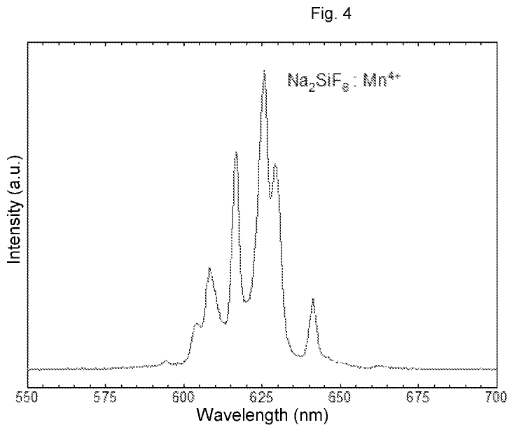

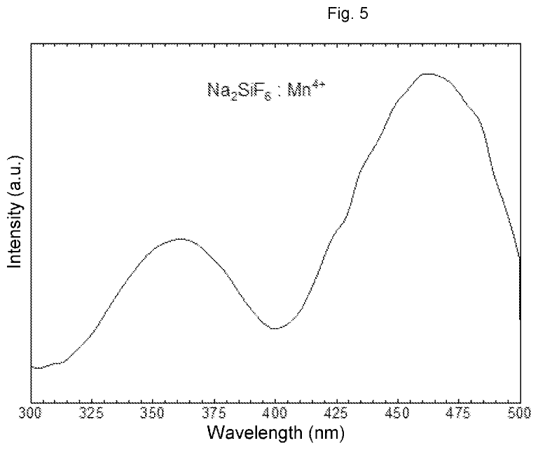

The emission spectra of the luminophores Na₂SiF₆:Mn⁴⁺ obtained according to example 4 or example 5 are presented in FIGS. 4 and 5 according to an excitation at 450 nm or 625 nm respectively.

### Example 6—Synthesis of K₂SiF₆:Mn⁴⁺ by Static Fluorination with Pure Silicon

The initial composition comprises, as first synthetic precursor A′, potassium bromide (KBr), as second synthetic precursor B′, silicon (Si), and, as chemical doping source C′, manganese(II) fluoride (MnF₂). The synthetic precursors and the chemical doping source are ground with ethanol and mixed in order to obtain a homogeneous powder. The mixture is placed on a nickel boat and is introduced into a fluorination oven. A stage of heating the initial composition up to a temperature of 350° C. is carried out under nitrogen. The oven is placed under vacuum, for example at a relative pressure of −1 bar, then an injection of fluorine is carried out, for example up to a relative pressure of −0.2 bar. This state is maintained for 3 hours at the fluorination temperature of 350° C. The oven is subsequently cooled down to a temperature of 20° C., still under a fluorine atmosphere. Flushing with nitrogen is carried out in order to recover the sample. A yellow powder is obtained, characteristic of the compound K₂SiF₆ doped with Mn⁴⁺ ions.

The different embodiments presented in this description are not limiting and can be combined together. In addition, the present invention is not limited to the embodiments described above but extends to any embodiment coming within the scope of the claims.

1. A process for the dry synthesis of a luminophore of formula Aₓ[BF_{y}]:C, A being a chemical element from Li, Na, K, Rb, Cs or a combination of at least two of these chemical elements, B being a chemical element from Si, Ge, Sn, Ti, Zr, Al, Ga, In, Sc, Hf, Y, La, Nb, Ta, Bi, Gd or a combination of at least two of these chemical elements, F being fluorine, C being a doping chemical element, x being the number of atoms of the element A and being equal to 1, 2 or 3, y being the number of atoms of the element fluorine and being equal to 5, 6 or 7,
the process comprising the following stages:
a) a stage of providing an initial composition, the initial composition comprising at least one first synthetic precursor A′, at least one second synthetic precursor B′ and at least one chemical doping source C′,
b) a stage of heating the initial composition up to a fluorination temperature of between 200 and 550° C., the heating stage being carried out under an inert atmosphere or under vacuum,
c) a stage of treatment under a fluorine atmosphere of the composition obtained on conclusion of the heating stage, comprising the following successive substages:
c1) a substage of maintaining at the fluorination temperature,
c2) a substage of cooling from the fluorination temperature down to a temperature of less than or equal to 150° C.,
d) a stage of returning to ambient temperature under an inert atmosphere the composition obtained on conclusion of the stage of treatment under a fluorine atmosphere.

2. The process as claimed in claim 1, the maintenance substage c1) being carried out for a period of time of 30 minutes to 8 hours.

3. The process as claimed in claim 1, the first synthetic precursor A′ comprising at least one chemical element chosen from Li, Na, K, Rb and Cs, preferably a halide of these elements.

4. The process as claimed in claim 3, the first synthetic precursor A′ being chosen from KBr, NaBr, KCl, NaCl.

5. The process as claimed in claim 1, the second synthetic precursor B′ comprising at least one chemical element chosen from Ge, Si and Ti.

6. The process as claimed in claim 5, the second synthetic precursor B′ comprising at least one chemical element chosen from Si and Ti.

7. The process as claimed in claim 6, the second synthetic precursor B′ being chosen from Si, Ti, SiO_{z} and TiO_{z}, z being equal to 1 or 2.

8. The process as claimed in claim 1, the doping source C′ being chosen from Mn, KMnO₄, MnO, MnO₂, MnBr₂, MnF₂, MnF₃, MnCl₃ and MnCl₂, preferably being MnCl₃ or MnCl₂.

9. The process as claimed in claim 1, the first synthetic precursor A′ and/or the second synthetic precursor B′ and/or the doping source C′ being in the form of powders consisting of grains having a particle size of between 100 nm and 50 μm.

10. The process as claimed in claim 1, the molar ratio A′/B′ of the first synthetic precursor A′ to the second synthetic precursor B′ being between 5 and 0.5.

11. The process as claimed in claim 1, the molar ratio B′/C′ of the second synthetic precursor B′ to the chemical doping source C′ being between 50 and 5.

12. The process as claimed in claim 1, the inert atmosphere being a nitrogen atmosphere.

13. The process as claimed in claim 1, the fluorine atmosphere being obtained by flushing fluorine with a flow rate of between 10 and 100 ml per minute.

14. A composition comprising a luminophore of formula Aₓ[BF_{y}]:C, A being a chemical element from Li, Na, K, Rb, Cs or a combination of at least two of these chemical elements, B being a chemical element from Si, Ge, Sn, Ti, Zr, Al, Ga, In, Sc, Hf, Y, La, Nb, Ta, Bi, Gd or a combination of at least two of these chemical elements, F being fluorine, C being a doping chemical element, x being the number of atoms of the element A, y being the number of atoms of the element fluorine, the composition being devoid of hydrogen fluoride and being obtained by the method as claimed in claim 1.

15. The composition as claimed in claim 14, comprising between 0.5% and 2% by weight of doping chemical element C.
